(19) United States
(12) Patent Application Publication
(10) Pub. No.: US 2009/0042174 A1
(43) Pub. Date: Feb. 12, 2009

(54) System and Method for Encouraging Children to Exercise

(75) Inventor: Richard D. Aries, Agoura Hills, CA (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: KNUCKLEHEADS, INC., Newbury Park, CA (US)

(21) Appl. No.: 12/186,590

(22) Filed: Aug. 6, 2008

Related U.S. Application Data
(60) Provisional application No. 60/954,465, filed on Aug. 7, 2007.

(51) Int. Cl. G09B 19/00

(52) U.S. Cl. 434/247

(57) ABSTRACT

A method of encouraging children to physically exercise comprises providing a plurality of exercise equipment configured to induce physical exercise through entertainment. The entertainment aspect is integrated with the exercise equipment and/or is made available separately. As such, equipment inducing physical exercise through entertainment are an improvement over conventional exercise equipment.

### CROSS-REFERENCE TO RELATED APPLICATION(S)

This application claims the benefit of U.S. Provisional Patent Application Ser. No. 60/954,465 filed Aug. 7, 2007, titled “System and Method for Encouraging Children to Exercise,” the entirety of which is hereby incorporated by reference.

### TECHNICAL FIELD

This invention relates to health clubs and other health facilities and, more specifically, to ways in which children can be encouraged to exercise while at health facilities.

### BACKGROUND

Healthcare is a critical part of our society. Preventive healthcare, including weight control and aerobic exercising, is well understood to be very important to a person's health and to our society's health overall.

The health club industry is serious business intended to give people, at a price, a location and means for its members to work out to maintain, lose, and sometimes even gain weight or mass and to aerobically exercise. Members also use the clubs to train for or simply enjoy a particular sport or sporting event, relax in a steam bath, hot tub, or the like, and simply gather and socialize. Some of the most common forms of sport and other exercise activities include tennis, handball, racquetball, squash, basketball, running, weightlifting (with free weights or machines), group aerobics, calisthenics, and dancing. Some of the aerobic equipment includes treadmills, stair climbers, rowing machines, large balls, step-up platforms, and elastic/resistance bands.

Most of the clubs and their activities are geared toward adults, though some like YMCA are geared as much toward more youthful members. The clubs geared toward the youth offer children's programs in swimming, basketball, and other sports. They organize camping and other off-site activities. These youth-geared clubs also host birthday parties.

Health clubs, including those geared toward children, have not made use of certain methods to attract many children to the health club and entice them to get a healthy work-out.

### SUMMARY

A method of encouraging children to physically exercise comprises providing a plurality of exercise equipment in conjunction with an aspect of entertainment. The entertainment aspect is integrated with the exercise equipment and/or is made available separately. As such, exercise equipment having a combined aspect of inducing physical exercise through entertainment are an improvement over conventional exercise equipment. In an aspect of the invention, credits are issued for redemption at an entertainment center, obtaining merchandise, etc.

### BRIEF DESCRIPTION OF THE DRAWINGS

The figures in this application are exemplary and illustrative of one or more embodiments of the present invention and, therefore, are not intended to limit the scope of the invention.

FIG. 1 is a perspective view of an embodiment wherein one child is exercising while another is using an entertainment center in between physical exercises.

FIG. 2 is a perspective view of an exergame sold under the trademark Dance Dance Revolution™.

### DETAILED DESCRIPTION

While multiple embodiments of the instant invention are disclosed, still other embodiments may become apparent to those skilled in the art. The following detailed description shows and describes only illustrative embodiments of the invention. It should be clearly understood that there is no intent, implied or otherwise, to limit the invention in any form or manner. As such, all alternative embodiments of the invention are considered falling within the spirit, scope and intent of the disclosure.

Applicant has conceived of certain methods usable at or in conjunction with a health club or other health facility to attract children to the facility and entice them to work out while there, for example, to the point of getting an aerobic work-out of a useful duration. As used herein, the terms children or child respectively imply minor children or a minor child, including those of an adolescent age or younger. The following disclosure describes and illustrates several exemplary embodiments of the present invention and illuminates still other embodiments. A number of the embodiments are described with various elements or aspects, will illuminate other embodiments based on different combinations, permutations, and subsets of those aspects.

One embodiment involves encouraging children to exercise using an environment and equipment such that the children are not intimidated by exercise and do not perceive the inventive method as being hard work. This involves having the children perceive the method as being fun, i.e., what the children want to do rather than what they have to do. An activity that many children find fun and not hard work is gaming. Other interactive activities are similarly perceived to be fun such that they are not perceived as hard work or drudgery.

An aspect of this invention involves gathering in one place or under one roof, i.e., a health club or other health-driven facility, a number of gaming and other interactive systems, including e.g., computers running games. In particular, these games or activities involve the person getting exercise while playing. Some of these exercise games or activities, generally known as exergames, include simulations of dance and other sports such as products sold under the trademark Dance Dance Revolution™, Dancetown™, Wii™, 3-Kick, Cybex Trazer™, Expresso™ bikes, Exercisers™, eXerbike™, Game Cycle™, Exerstation™, Hogan Airbounder™, Jacobs Ladder™, Freedom Climber™, KidWall™, Traversing Wall™, TreadWall M4Base™, TreadWall M4Pro™, Touch Wall™, Sport Wall™, Skywall™, Lightspace Play Wall™, Lightspace Play Floor™, Alpha Mats™, XaviX J-Mat™, PaviPlay Flooring™, iJoy Board™, Motivatrix™, Makoto Sports Arena™, Traq 3D™, Exercisers™, Gamercize Products™, XaxiX Power Boxing™, and XaviX Tennis™.

There are a number of steps for attracting children to go to a health facility like a health club and for motivating them to work out, i.e., exercise once there. They can involve advertising, publicizing, or otherwise spreading the word directly to children in various forms, e.g., TV/radio/internet ads, materials distributed at schools, of activities particularly interesting to children that they get to do if they come to the facility and work out. The activities that attract/interest children vary from child-to-child as do the exercises the children are willing to try and do. These variations can be matched up in various ways, including on a child-by-child basis, even for a particular child during a particular visit to the facility. The matching of these variations can be done by a person working at the facility, by a computer program, a chart at the facility, or by the child his- or herself (or guardian), within the limits of what is suitable for the child.

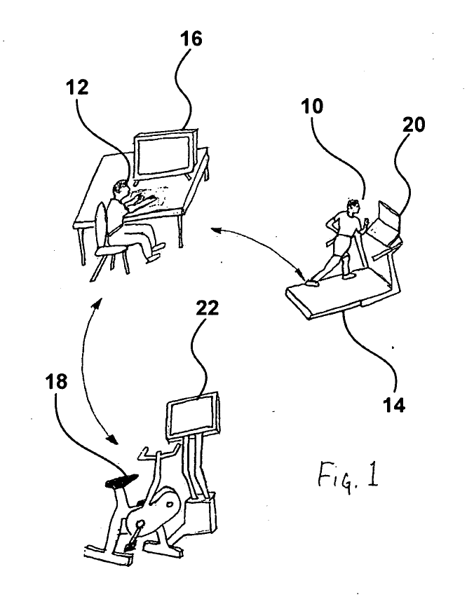

FIG. 1 shows two children 10 and 12, with child 10 exercising on a treadmill 14 while the other child 12 is taking a break between exercise sessions using a children-desired activity center 16 that serves as a reward or incentive for exercising. Also shown is stationary bike 18 for another form of exercise. For example, if a child jogs or walks quickly for a total of 20 minutes, the child would get access to a fun activity at activity center 16 during an exercise break, like a video game, listening to music, or text-messaging a friend. Similarly, if a child completes 3 sets of 20 repetitions on a rowing machine set at a particular resistance level, 10 minutes on an exercise bike at an average pace of 10 miles per hour, that child would be given 5 minutes of credit on activity center 16 to send emails or text/instant messages to friends.

Another embodiment relates to monitors 20 and 22 on which video games, music videos, and clips from certain popular children movies or TV programs can be played while the child is exercising. As illustrated in FIG. 1, monitor 20 is associated with treadmill 14 and monitor 22 is associated with stationary bike 18.

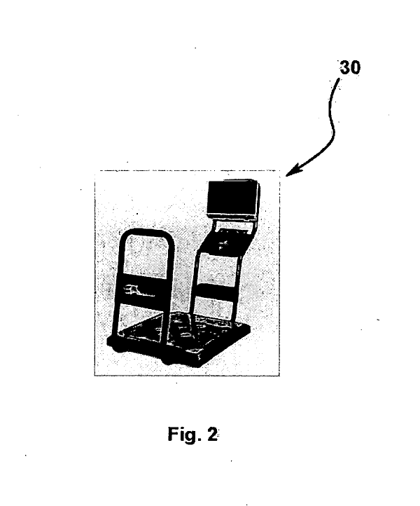

A variation of the embodiment shown in FIG. 1 is a video being played on the monitor that is to be mimicked by the child as part of the exercise, such as a calisthenics, boxing, tennis, etc. FIG. 2 is a perspective view of exergame 30 sold under the trademark Dance Dance Revolution™. Exergame 30 is a video dance equipment whereon a user stomps, slides, spins and dances to various dance programs while burning calories and earning credits or as a reward.

Another embodiment involves the selection of the physical environment of the facility. This could include its graphics, colors, lighting, background music, background video, posters, the age, attire and attitude of the employees, guest appearances, the choice of food and beverage, rearrangement of the environment, separation from adult areas, etc. that are particularly attractive or interesting to children, as opposed to a different selection or combination of attributes that are more attractive to adults. The selection or combination of the above-noted children-attracted attributes can vary by age group of the children. For example, certain areas could have bright colored walls for the younger children and darker or bolder colors for older children. Similarly, the background music and videos could be age-specific.

Another embodiment relates to issuing credits to a child who completes certain exercise activities. All or a portion of the credits can then be redeemed for merchandise such as toys, t-shirts, hats, etc., or for activities such as time on video games, music videos, movies, etc. The exercises could be, for example, 3 sets of 20 repetitions on a rowing machine set at a particular resistance level, 10 minutes on an exercise bike 18 at an average pace of 10 miles per hour, etc.

Another embodiment involves the use of computers that are set up to do research on health, exercise, sports, sports personalities, science and other subjects that relate to sports and/or exercising. Access to such a computer could be one of the rewards or between-exercise activities noted above.

Still other embodiments similar to those described above are contemplated and within the spirit of this disclosure. For purposes of this disclosure, the term children is intended to include children who are old enough such that an exercise program is healthy, such as a four-year old, as well as adolescents such as high schoolers. Accordingly, the scope of the present invention is intended to embrace all such alternatives, modifications, and variations as falling within the scope and intent of the appended claims, including all equivalents thereof.

What is claimed is:

1. A method of encouraging children to physically exercise, the method comprising the step of providing a plurality of exercise equipment at a facility, wherein the exercise equipment is configured to induce children to physically exercise through entertainment.

2. The method of claim 1, wherein the physical exercise is an aerobic activity.

3. The method of claim 1, wherein the exercise equipment includes a gaming center.

4. The method of claim 1, wherein the exercise equipment includes one more exergame.

5. The method of claim 4, wherein the one or more exergame comprises one or more of the product sold under the trademark Dance Dance Revolution™, Dancetown™, Wii™, 3-Kick, Cybex Trazer™, Expresso™ bikes, Exercisers™, eXerbike™, Game Cycle™, Exerstation™, Hogan Airbounder™, Jacobs Ladder™, Freedom Climber™, KidWall™, Traversing Wall™, TreadWall M4Base™, TreadWall M4Pro™, Touch Wall™, Sport Wall™, Skywall™, Lightspace Play Wall™, Lightspace Play Floor™, Alpha Mats™, XaviX J-Mat™, PaviPlay Flooring™, iJoy Board™, Motivatrix™, Makoto Sports Arena™, Traq 3D™, Exercisers™, Gamercize Products™, XaxiX Power Boxing™, and XaviX Tennis™.

6. The method of claim 1, further comprising the steps of:
obtaining a credit, wherein the credit is determined as a function of the physical activity completed;
accessing one or more entertainment center; and
redeeming at least a portion of the credit at the one or more entertainment center.

7. The method of claim 6, wherein the one or more entertainment center is a device comprising at least one microprocessor.

8. The method of claim 6, wherein the one or more entertainment center comprises one or more of: an electronic gaming device, access to the internet, audio, video.

9. The method of claim 1, further comprising the steps of:
obtaining a credit, wherein the credit is determined as a function of the physical activity completed; and
redeeming at least a portion of the credit for merchandise.

10. An improved exercise equipment for encouraging children to physically exercise, wherein the improvement comprises a plurality of exercise equipment configured to induce children to physical exercise through entertainment.

11. The improved exercise equipment of claim 10, wherein the exercise equipment comprises a gaming center.

12. The improved exercise equipment of claim 10, wherein the exercise equipment comprises one or more exergame.

13. The improved exercise equipment of claim 12, wherein the exergame comprises one or more of the product sold under the trademark Dance Dance Revolution™, Dancetown™, Wii™, 3-Kick, Cybex Trazer™, Expresso™ bikes, Exercisers™, eXerbike™, Game Cycle™, Exerstation™, Hogan Airbounder™, Jacobs Ladder™, Freedom Climber™, KidWall™, Traversing Wall™, TreadWall M4Base™, TreadWall M4Pro™, Touch Wall™, Sport Wall™, Skywall™, Lightspace Play Wall™, Lightspace Play Floor™, Alpha Mats™, XaviX J-Mat™, PaviPlay Flooring™, iJoy Board™, Motivatrix™, Makoto Sports Arena™, Traq 3D™, Exercisers™, Gamercize Products™, XaxiX Power Boxing™, and XaviX Tennis™.

14. The improved exercise equipment of claim 10, wherein the exercise equipment includes means for issuing a credit determined as a function of the physical exercise completed.

15. The improved exercise equipment of claim 14, further comprising one or more entertainment center whereat at least a portion of the credit is redeemable.

16. The improved exercise equipment of claim 15, wherein the one or more entertainment center comprises at least one microprocessor.

17. The improved exercise equipment of claim 15, wherein the one or more entertainment center comprises one or more of: an electronic gaming device, access to the internet, audio, video.

18. The improved exercise equipment of claim 14, wherein at least a portion of the credit is redeemed for merchandise.
